(19) United States
(12) Patent Application Publication
(10) Pub. No.: US 2012/0091188 A1
(43) Pub. Date: Apr. 19, 2012

(54) SOLDER POT

(75) Inventor: Bassem Elhage, Saint Loup de Fribois (FR)

(73) Assignee: ROBERT BOSCH GMBH, Stuttgart (DE)

(21) Appl. No.: 13/377,587

(22) PCT Filed: Jun. 9, 2010
(86) PCT No.: PCT/EP10/58086

§ 371 Date: Dec. 12, 2011

(30) Foreign Application Priority Data
Jun. 10, 2009 (FR) 0902820

(51) Int. Cl. B23K 1/20; B23K 3/06

(52) U.S. Cl. 228/259; 228/56.1

(57) ABSTRACT

Solder pot intended for a machine for selective soldering of through-hole electronic components on a printed circuit board, characterized in that it is in the form of a right prism, preferably with a hexagonal base.

### BACKGROUND OF THE INVENTION

The present invention relates to a solder pot intended for a machine for selective soldering of through-hole electronic components on a printed circuit board, and to a process employing such a pot.

A printed circuit board is a punched, perforated or countersunk rigid substrate on which there are surface-mounted electronic components (called SMCs), connected on one or both of its sides, and electroplated holes that are used for the insertion of the pins of through-hole components to be soldered—there may be any number of these components.

The printed circuit board is a two-part component: one part is called the “insulating” part and the other part is called the “conducting” part.

The insulating part, called a “prepreg”, consists of a resin-impregnated reinforcement. This reinforcement is often made of fibre glass and takes the form of a woven fabric, but it may also be made of quartz, or of synthetic fibres sold under the Kevlar trademark.

The base material of a two-sided printed circuit board therefore consists of a number of prepregs covered on both external sides with copper sheets.

The base material of a multilayer printed circuit board consists of several prepregs between which intermediate copper sheets are placed, the assembly being covered on both external sides with copper sheets.

The conducting part consists of a sheet of 99.9%-pure copper; it is characterized by its thickness and its physical properties.

The sheet obtained is then cut to the desired dimensions and drilled according to the lay-out; the drill holes are then plated through-holes (by copper plating). The lay-out is then “designed”, the varnish mask is deposited and finally the tinning or gold-plating is carried out.

The tinning, coating with a solderable varnish lacquer or gold-plating of printed circuit boards provides corrosion protection.

Selective soldering using pots serves for mechanical and electrical connection between through-hole components, which are inserted manually or automatically, and a printed circuit board.

This connection is produced using a solder, in the liquid state, having a melting point lower than that of the parts to be joined and wetting the surfaces that do not take part, by melting, in the formation of the solder joint.

The metallurgical reaction between the solder and the parts to be soldered and the surface finish of the parts to be soldered are important factors in the soldering.

Selective soldering using pots requires implementation of a series of specific steps the first of which consists in positioning the printed circuit board on a holder so that it may be moved through the soldering machine and inserting the pins of the components to be soldered into the plated through-holes, whether manually or using a robot.

The following step consists in transferring the assembly, formed by the holder on which one or more printed circuit boards bearing the components to be soldered have been inserted, to a fluxing station.

Fluxing consists in chemically preparing and cleaning the surfaces to be soldered by subjecting them to the action of an acid-based or alcohol-based corrosive flux, so as to remove oxides that might possibly have formed thereon and so as to contribute simultaneously to the good wetting of these surfaces by the solder, by promoting and accelerating formation of a thin layer of an intermetallic compound between the solder and the base metal.

During this treatment, the components to be soldered are held pressed against the printed circuit board via spring-loaded pressure plates and the solder flux is applied to the circuit board using brushes mounted on a specific fluxing matrix that can move translationally so as to be dipped into and immersed in the flux bath.

After the fluxing step, the printed circuit board and the holder are subjected to a preheating step (generally convective preheating or preheating using infrared resistance heaters).

After the preheating, the surface to be soldered is brought to a temperature generally between 95° C. and 125° C.

The preheating serves to evaporate the alcohol of the flux deposited beforehand, to activate the flux and to bring the printed circuit board and the components inserted thereinto to a temperature that is high enough to prevent thermal shocks during the soldering step.

At the end of the preheating step, the holder is gripped by a manipulator arm in order to position it at the actual soldering station.

This positioning must be carried out reproducibly and with great precision in a horizontal plane having axes X and Y.

The soldering station consists of a tank, closed from above using a plate specific to the printed circuit board and a cover (generally a window), the role of which is to keep the tank sealed outside of a soldering cycle.

The tank is filled with solder made of 63% tin and 37% lead, the melting point of which is 183° C.

The solder bath is kept at a temperature of about 300° C. to 325° C. and under an inert atmosphere, by virtue of a nitrogen flow, so as to prevent it from oxidizing.

The solder bath moreover contains a soldering matrix consisting of a plate bearing a series of solder pots the shape of which varies depending on the geometry of the regions to be soldered on the printed circuit board.

The soldering matrix can move translationally along the Z-axis.

To allow production of the solder joint using the pots, the cover protecting the solder bath is opened to allow the pots to pass, which pots progressively rise until they make contact with the underside of the printed circuit board and are held in this configuration for a few seconds.

The top of the solder contained in the solder pots must form a convex cap.

When this cap makes contact with the printed circuit board, the solder can thus infiltrate, by capillary action, into the plated through-holes holes along the pins of the components to be soldered, and the excess solder coming from the cap flows away through small slots cut for this purpose in the edge of the pot.

For the solder to flow properly, along the pots, the solder must correctly wet the surfaces of the pots.

After the time allowed for the soldering has elapsed, the pots descend, returning to the solder bath, the cover is closed and the holder is removed.

During this operation, the components to be soldered are held pressed against the printed circuit board by spring-loaded pressure plates so as to prevent them from moving.

The capillary-action soldering process is subject to malfunctions that may have various origins, in particular the temperature of the solder, which, if it is colder than the printed circuit board and the pins of the electronic components to be soldered, cannot rise by capillary action into the plated through-holes holes, so that it is then impossible to obtain a correct solder joint.

The geometry of the solder pots must be chosen so as to take this constraint into account, i.e. they must contain enough solder to store a sufficient amount of heat when the pots are moved close to the pins of the electronic elements to be soldered.

However, it is not possible to choose any geometry in that it is necessary to take into account, in each particular case, regions called “taboo” regions, i.e. free regions around each of the pins of the electronic components to be soldered, so as in particular to remove any risk of the solder making contact with neighbouring electronic components already fixed onto the printed circuit board, contact being liable to damage these components or cause short circuits.

The major problem encountered in selective soldering using pots is however related to the wettability of the surface of the solder pots by the solder.

To enable correct soldering, it is in particular essential for the solder contained in a solder pot to have a convex spherical cap on the surface so that, on contact with the pin of an electronic component to be soldered, the solder can infiltrate into the plated through-holes hole surrounding the pin and wick up along the latter by capillary action, and so that the excess solder can escape via slots provided for this purpose in the upper edge of the pot and flow along its external walls before falling back into the solder bath.

It is therefore essential that the meniscus of the solder contained in a solder pot be not concave and that the excess solder be not liable to overflow and spread over the surface of the printed circuit board to be soldered and the neighbouring electronic components, which could thus be damaged.

Now, this requirement depends on the wettability of the pots by the solder.

The pots used are made of E24 mild steel chemically tinned with a uniform tin layer about 20 μm in thickness, so as to optimise the wetting of the solder on the steel.

Chemical tinning of the steel pots forms a thin, uniform, intermetallic FeₓSn_{y} layer 1 μm in thickness between the iron and the tin; when new, the solder pots therefore have a satisfactory wettability.

However, as soon as the pots are immersed in the solder bath, the temperature of which is 300° C.-325° C., the pure tin layer covering the new pots melts and completely disappears; the solder then makes direct contact with a 20 μm thick FeₓSn_{y} layer and the steel/tin interface becomes irregular.

This layer is wettable when the pots are new but, over the course of their use, this layer thicken and becomes irregular because tin diffuses from the solder into the steel and because oxide layers appear on the surface of the pots, thereby making these surfaces passive and consequently causing them to lose their wettability.

To prevent aging of the pots, it is essential to carry out frequent cleans.

The aim of this cleaning is to remove the surface impurities from the pots and to slow the growth of the intermetallic FeₓSn_{y} layer.

This preventive cleaning operation is carried out manually using brushes and is particularly awkward due to the small size of the pots and the presence of dead zones which are difficult to reach and is furthermore dangerous in that it must be carried out in a hot zone, thereby obliging personnel to take specific precautions and to wear protective means such as helmets, visors, etc.

The solder pots employed in processes for selectively soldering printed circuit boards, using pots, are conventionally cylindrical.

For a machine operating twenty-four hours a day, such pots must be preventively cleaned, stopping the machine for about 15 minutes, six times per day.

In addition, the pots must be replaced every month and a half.

These demanding preventative measures do not however make it possible to meet the desired quality requirements, which are becoming increasingly strict, and very many soldering defects are still observed, in particular critical soldering defects such as unsoldered points, problems in the wicking of solder into the plated through-holes holes, overflow of the solder onto the top side of the printed circuit board and onto neighbouring electronic components.

### SUMMARY OF THE INVENTION

The object of the present invention is to obviate these drawbacks.

It has been observed, in accordance with the invention, that the shape of the solder pots greatly influences the quality of the soldering and in particular the effectiveness of the preventive cleaning of these pots, and many trials were therefore carried out with the aim of finding the optimal shape.

In this context, the present invention provides a solder pot intended to be employed in a process for selectively soldering printed circuit boards using pots, characterized in that it comprises at least one planar vertical wall.

According to another feature of the invention, the pot is in the form of a right prism.

According to another feature of the invention, the base of the prism is hexagonal.

According to another feature of the invention, the pot is characterized in that the base of the prism is a regular hexagon or, in other words, the pot is honeycomb-shaped.

Specifically, it has surprisingly been observed that pots having a honeycomb shape make it possible:

to reduce by 65% the number of selective soldering defects;

to increase customer satisfaction;

to improve the effectiveness of preventive cleaning of the pots and consequently the stability and wettability of the pots by the solder;

to half the frequency of preventive cleaning of the pots, for a machine operating twenty-four hours a day, leading to an increase in uptime of 45 minutes per day; and

to replace the pots only every three months.

As a corollary, the safety of personnel tasked with implementing the process is also notably increased.

### BRIEF DESCRIPTION OF THE DRAWINGS

The characteristics of the solder pot, which is the subject of the invention, will be described in more detail with reference to the annexed non-limiting drawings, in which:

FIG. 1 shows a printed circuit board;

FIG. 2 is a schematic view illustrating the soldering step;

FIGS. 3a, 3b and 3c are diagrams respectively illustrating an example of correct soldering and two examples of defective soldering; and

FIG. 4 shows a solder pot according to the invention.

### DETAILED DESCRIPTION

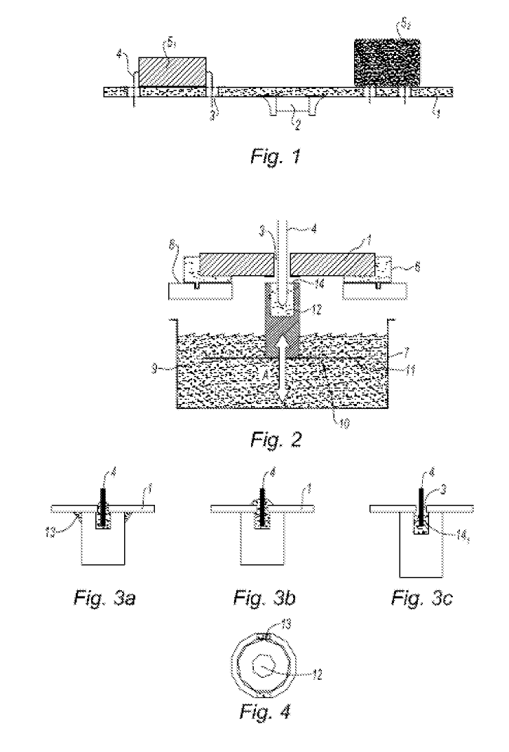

According to FIG. 1, the printed circuit board 1 bears an electronic component 2 already fixed to its top side, and is pierced with plated throughholes holes 3 into which the pins 4 of two components to be soldered 5₁ and 5₂, positioned on its top side, are inserted.

In FIG. 2, the printed circuit board 1 is shown schematically as a single pin 4 and is shown in the soldering position.

This printed circuit board 1 is placed on a holder 6 and is subjected beforehand to fluxing and preheating steps.

The soldering zone, which is also shown schematically, consists of a tank 7, closed from above using a specific plate 8 and a cover, the role of which is to keep the tank sealed outside of a soldering cycle.

The tank 7 is filled with solder 9, consisting of 63% tin and 37% lead, kept at a temperature of about 300° C. to 325° C. under a neutral atmosphere.

The tank 7 moreover contains a soldering matrix 10 consisting of a supporting plate 11 bearing a set of solder pots 12 only one of which is shown.

The solder pots 12 are distributed over the supporting plate 11 in a geometry corresponding to that of the regions to be soldered on the printed circuit board 1 so that a solder pot 12 is located in line with each of the pins 4 of the components 5₁, 5₂ that have to be soldered (FIG. 1).

In FIG. 4, the solder pots 12 are right prisms with hexagonal bases, i.e. they have a honeycomb shape, and are equipped at their upper edge with two slots 13 which have a height of about 0.3 mm and have the function of allowing the excess solder to be removed.

In FIG. 2, the soldering matrix 10 can move in translationally along the Z-axis, as shown schematically by the double-headed arrow A.

The solder pots may thus move vertically between a low position (not shown) in which they are dipped into the solder bath 9, so as to be filled with this solder, and a high position (shown in FIG. 2) in which the upper cap 14 of the solder contained therein makes contact with the underside of the printed circuit board and the associated pin 4.

In FIGS. 2 and 3a, the solder 9, the top of which has a convex cap, contained in the pots 12 then infiltrates by capillary action into the plated through-holes holes 3 along the pin 4 of the electronic components 5₁, 5₂ that have to be soldered and wicks up along these pins.

In FIG. 3a, the excess solder coming from the cap escapes via the slots 13 located in the upper edge of the pots 12 and flows along the external walls of these pots before falling into the solder bath 9.

Producing such correct solder joints requires the surfaces of the pots 12 to be satisfactorily wettable by the solder and the top part of this solder to form a convex spherical cap 14.

This is because, as shown in FIG. 3b, in the case of poor wettability of the solder pots 12, the excess solder cannot escape via the slots 13 but instead overflows and spreads over the upper surface of the printed circuit board 1 where it then runs the risk of damaging the neighbouring electronic components and thus generating soldering defects.

In addition, and as shown in FIG. 3c, in the presence of a concave spherical cap 14, the solder cannot completely infiltrate into the plated throughholes holes 3 by capillary action along the pins 4 of the electronic components 5₁, 5₂ that have to be soldered, and the connection between the pin of the component and the printed circuit board is defective.

### NOMENCLATURE

1 Printed circuit board
2 Electronic component
3 Plated through-holes holes
4 Pins
5₁, 5₂ Components to be soldered
6 Holder
7 Solder tank
8 Cover+specific plate
9 Solder
10 Soldering matrix
11 Supporting plate
12 Solder pots
13 Slots
14 Convex spherical cap
14₁ Concave spherical cap

1. A solder pot for a machine for selective soldering of through-hole electronic components on a printed circuit board, the solder pot comprising at least one planar vertical wall so as to form a right prism having a hexagonal base.

2. The solder pot according to claim 1, characterized in that the base of the prism is a regular hexagon.

3. The solder pot according to claim 1, characterized in that the pot comprises a slot (13) in the upper edge of said vertical wall.

4. The solder pot according to claim 2, characterized in that the pot comprises two slots (13) located in two opposite walls of said pot.

5. (canceled)

6. The solder pot according to claim 1, characterized in that the base of the prism is honeycomb-shaped.

7. The solder pot according to claim 2, characterized in that the pot comprises a slot (13) in the upper edge of said vertical wall.

8. The solder pot according to claim 7, characterized in that the pot comprises two slots (13) located in two opposite walls of said pot.

9. The solder pot according to claim 6, characterized in that the pot comprises a slot (13) in the upper edge of said vertical wall.

10. The solder pot according to claim 9, characterized in that it the pot comprises two slots (13) located in two opposite walls of said pot.

11. A soldering process comprising:
at partially filling a pot according to claim 1 with solder; and immersing at least one pin (4) of an electrical or electronic component in said pot.

12. A process according to claim 11, characterized in that the base of the prism is a regular hexagon.

13. A process according to claim 11, characterized in that the pot comprises a slot (13) in the upper edge of said vertical wall.

14. A process according to claim 12, characterized in that the pot comprises two slots (13) located in two opposite walls of said pot.

15. A process according to claim 11, characterized in that the base of the prism is honeycomb-shaped.

16. A process according to claim 12, characterized in that the pot comprises a slot (13) in the upper edge of said vertical wall.

17. A process according to claim 16, characterized in that the pot comprises two slots (13) located in two opposite walls of said pot.

18. A process according to claim 15, characterized in that the pot comprises a slot (13) in the upper edge of said vertical wall.

19. A process according to claim 18, characterized in that the pot comprises two slots (13) located in two opposite walls of said pot.
